(19) United States
(12) Patent Application Publication
(10) Pub. No.: US 2007/0236918 A1
(43) Pub. Date: Oct. 11, 2007

(54) LIGHTING APPARATUS

(76) Inventors: Scott P. Lane, Roeland Park, KS (US); Jeffrey D. Lane, Mission, KS (US)

Correspondence Address: SPENCER, FANE, BRITT & BROWNE, 1000 WALNUT STREET, SUITE 1400, KANSAS CITY, MO, 64106-2140, US

(21) Appl. No.: 11/733,686

(22) Filed: Apr. 10, 2007

Related U.S. Application Data
(60) Provisional application No. 60/790,757, filed on Apr. 10, 2006.

(51) Int. Cl. F21V 1/00; F21V 19/00; F21V 11/00; F21V 21/00

(52) U.S. Cl. 362/147; 362/152; 362/145; 362/227; 362/238; 362/252; 362/257; 362/382; 362/404; 362/457

(57) ABSTRACT

The present invention encompasses a lighting apparatus comprising a rigid housing and a mounting handle coupled to the housing. The housing defines a channel into which a plurality of light sockets may be installed. The mounting handle defines an opening through which mounting hardware may extend to support the lighting apparatus on a building. The lighting apparatus may also have an installation handle coupled to the housing, with the installation handle defining an opening through which an installation tool may extend to assist in lifting the lighting apparatus during installation. In one embodiment, the present invention also includes a face plate coupled to the housing and positioned in front of the areas where the light sockets will extend. The face plate defines a plurality of openings that may be shaped in a decorative design or as letters.

### CROSS REFERENCE TO RELATED APPLICATIONS

This application claims the benefit of U.S. Provisional Application No. 60/790,757 entitled “Outdoor Lighting Apparatus,” filed Apr. 10, 2006. Priority is claimed thereto pursuant to 35 U.S.C. § 119(e).

### BACKGROUND OF THE INVENTION

The present invention relates generally a lighting apparatus and, more particularly, to an lighting apparatus that is easy and safe to install and remove from the exterior of a residence or other building.

Many people utilize lighting on the exterior of buildings for advertising purposes or homes for decorative purposes. For example, during the holidays many families add lighting to the exterior of their homes to create a festive, celebratory atmosphere. Typically, outdoor lighting is sold in strands consisting of a number of light sockets with lights installed therein and having insulated wire extending between and coupled to the light sockets. The strands may have a connector at each end coupled to the insulated wire, or the wire may be directly available, for connecting one strand with another strand or with a power source. Unfortunately, these strands are difficult to install so that the results are evenly spaced and pleasing in appearance.

One common method for installing such strands involves stapling the strands to the structure. This type of installation requires a person to climb a ladder to the position where the strand is to be installed while carrying both the strand and a staple gun. After placing a few staples, the person must descend the ladder, move it over, and then climb back up to place a few more staples. Other methods of installing strands, such as attaching mounting clips or hooks to the structure and then coupling the strand to the clips or hooks, also involve climbing up and down a ladder numerous times. Obviously, climbing up and down a ladder numerous times is tiresome and potentially dangerous.

Accordingly, it is desirable to provide a lighting apparatus that includes a rigid housing for supporting a plurality of light sockets and means for easily and safely mounting the housing to a structure.

### BRIEF SUMMARY OF THE INVENTION

There is, therefore, provided in the practice of the invention a lighting apparatus comprising a rigid housing and a mounting handle coupled to the housing. The housing defines a channel into which a plurality of light sockets may be installed. The mounting handle defines an opening through which mounting hardware may extend to support the lighting apparatus on a building.

In another embodiment of the invention, there is provided a lighting apparatus comprising a rigid housing defining a channel into which a plurality of light sockets may be installed and both a mounting handle and an installation handle are coupled to the housing. The mounting handle defines an opening through which mounting hardware may extend to support the lighting apparatus on a building. The installation handle defines an opening through which an installation tool may extend to assist in lifting the lighting apparatus during installation.

In yet another embodiment, the present invention provides a lighting apparatus comprising a rigid housing and a face plate coupled to the housing. The housing defines a channel into which a plurality of light sockets may be installed, and the face plate is positioned in front of the light sockets. The face plate defines a plurality of openings shaped in a decorative design.

### BRIEF DESCRIPTION OF THE DRAWINGS

Further features of the present invention will become apparent to those skilled in the art to which the present invention relates from reading the following description with reference to the accompanying drawings, in which:

FIG. 1 is a perspective view of lighting assembly according to one embodiment of the present invention;

FIG. 2 is a side view of the housing of FIG. 1;

FIG. 3 is a side view of holding clip of FIG. 1;

FIG. 4 is a side view of a mounting handle of FIG. 1;

FIG. 5 is a perspective view of the mounting handle of FIG. 4;

FIG. 6 is a side view of an installation handle of FIG. 1;

FIG. 7 is a perspective view of the installation handle of FIG. 6; and

FIG. 8 is a side view of the faceplate of FIG. 1.

### DETAILED DESCRIPTION OF THE INVENTION

The present invention includes a lighting apparatus that includes a rigid housing for a plurality of light sockets and means for easily and safely mounting the housing to a structure.

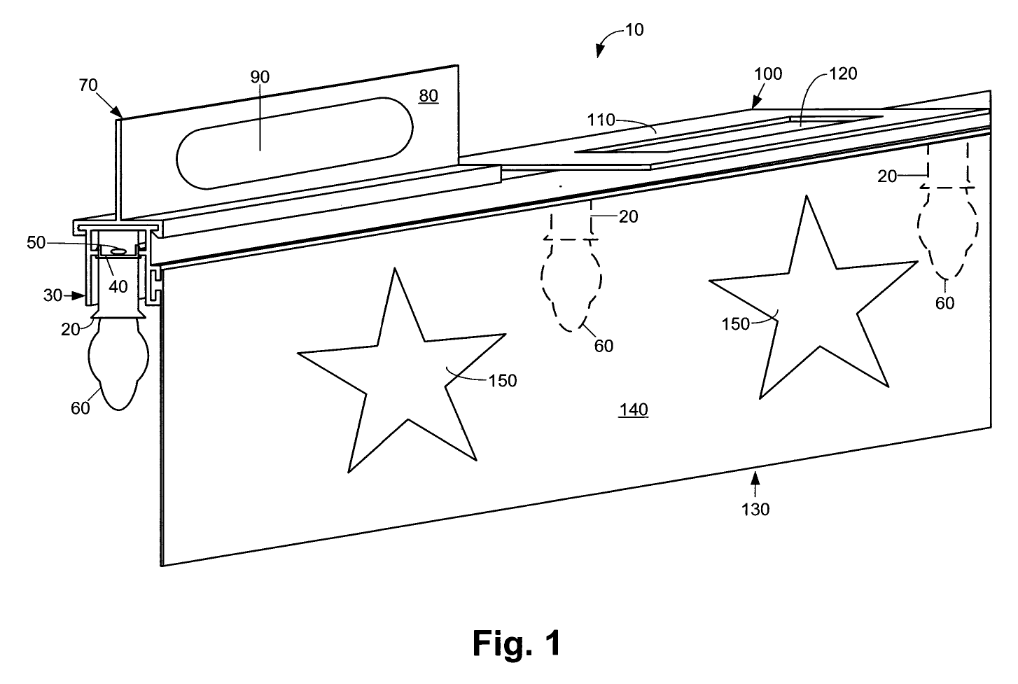

Turning now to the drawings, FIG. 1 shows one embodiment of the present invention 10 that includes plurality of light sockets 20 enclosed within a rigid housing 30. A holding clip 40 extends between each light socket 20 and supports the insulated wire 50 that is coupled to and between each light socket 20. Each light socket 20 contains a light bulb 60. A mounting handle 70 is coupled to the top of the housing 30 and has a main section 80 extending upwardly from the housing 30. The main section 80 of the mounting handle 70 defines an opening 90 to allow the mounting handle 70 to be hung on a hook, nail, or similar instrument. An installation handle 100 is also coupled to the top of the housing 30 and has a main section 110 that extends outwardly from the housing 30. The main section 110 of the installation handle 100 defines an opening 120 to allow a person to insert the end of an installation tool to assist in lifting the lighting apparatus 10 to its desired position. The lighting apparatus 10 also includes a face plate 130 that is coupled to one side of the housing 30. The face plate 130 has a main section 140 that extend downwardly in front of the light bulbs 60 and defines a plurality of openings 150 shaped in a decorative design.

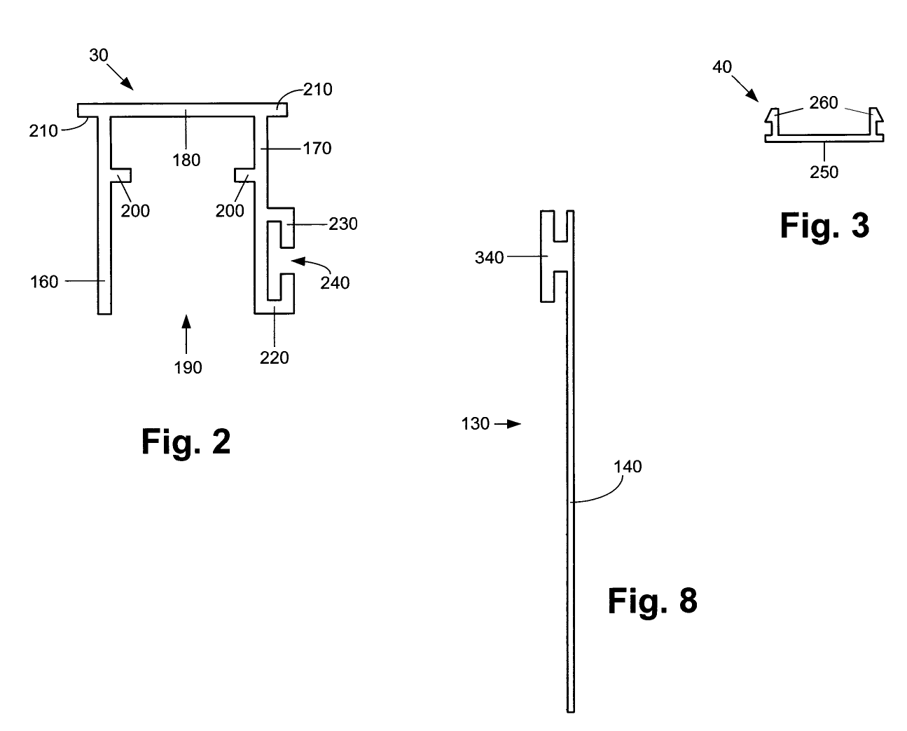

With additional reference to FIG. 2, the housing structure 30 generally includes a first side wall 160, a second side wall 170, and a top wall 180 that define a channel 190. Within channel 190, two interior flanges 200 extend from the side walls 160, 170. Top wall 180 extends beyond the side walls 160, 170 to form two exterior flanges 210. The bottom of side wall 170 extends out and then generally upward forming a bottom groove section 220. A top groove section 230 extends out and then generally downward so that in combination with bottom groove section 220 a groove 240 is formed. It should be understood that the housing 30 may have varying dimensions to accommodate both a variety of light sockets and different styles of lights.

Referring now to FIG. 1 and FIG. 3, the holding clip 40 includes a body section 250 having two stems 260 extending upward therefrom. With additional reference to FIG. 2, stems 260 are sized and shaped to act cooperatively with interior flanges 200 of housing 30 so that holding clip 40 may be inserted into channel 190 and the stems 260 forced past flanges 200. The stems 260 and body section 250 act with the flanges 200 to hold the holding clip 40 in place with body section 250 extending across channel 190. The holding clip 40 will have a length approximately equal to the space between light sockets 20, and thus when installed will support and restrict the movement of the light strand within the channel 190.

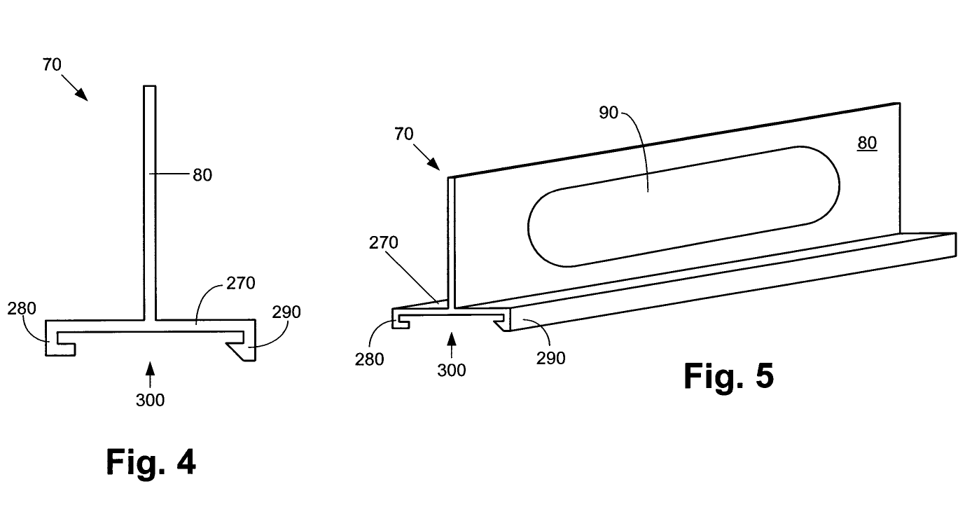

Referring now to FIGS. 1, 4, and 5, the mounting handle 70 includes a main section 80 that defines an opening 90. The main section 80 extends upwardly from a base section 270. One end of base section 270 extends downwardly and then inwardly to form a first mounting channel section 280 and the other end of base section 270 extends downwardly and inwardly to form a second mounting channel section 290. Base section 270, first mounting channel section 280, and second mounting section 290 define a mounting channel 300.

Referring additionally to FIG. 2, mounting channel sections 280 and 290 are sized and shaped to act cooperatively with exterior flanges 210 of housing 30 so that mounting handle 70 may be coupled onto housing 30. The mounting channel sections 280 and 290 and exterior flanges 210 of housing 30 act together keep the mounting handle 70 in place so that it may support the lighting apparatus 10 when it is mounted by inserting opening 90 over a hook, nail or other fastener.

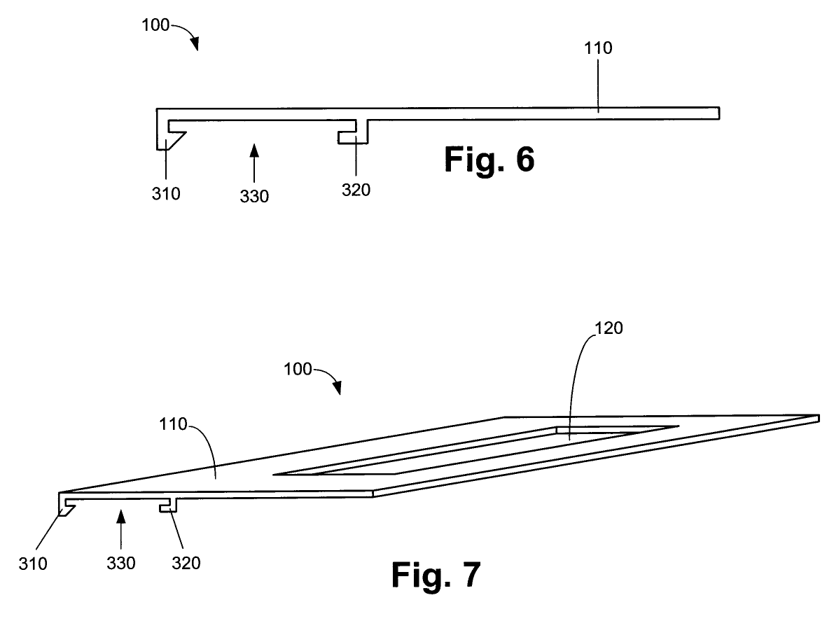

Referring now to FIGS. 1, 6, and 7, the installation handle 100 includes a main section 110 that defines an opening 120. The main section 110 extends outwardly from the housing 30. One end of main section 110 extends downwardly and then inwardly to form a first mounting channel section 310. A mounting channel section 320 extends downwardly and inwardly from the main section 110 to define a mounting channel 330.

Referring additionally to FIG. 2, mounting channel sections 310 and 320 are sized and shaped to act cooperatively with exterior flanges 210 of housing 30 so that installation handle 100 may be coupled onto housing 30. The mounting channel sections 310 and 320 and exterior flanges 210 of housing 30 act together keep the installation handle 100 in place so that it may support the lighting apparatus 10 when it is lifted for installation by inserting an installation tool such as a pole, through opening 120.

Turning now to FIGS. 1 and 8, face plate 130 includes a main section 140 that extend downwardly and defines a plurality of openings 150 shaped in a decorative design. At the top of main section 140, a tongue section 340 extends outwardly. Tongue section 340 is sized to fit within groove 240 so that the face plate 130 may slide onto the housing 30. With the face plate in place, the light from light bulbs 60 will show through the openings 150 and a view will see the decorative design. In the drawings, opening 150 is star shaped. It should be understood that the shape is not intended to be limiting and indeed many different decorative designs may be employed. Moreover, the openings 150 could be shaped like letters to form words (e.g. “Happy Holidays” or “Two Brothers' Lighting Store”) across the length of the face plate 130.

Having described the invention, it should be apparent that the invention successfully addresses the issues identified above, namely that it provides a seamless, smooth sleeping surface for a variable width bed in both its narrow width and its expanded width. Moreover, the present invention is both inexpensive and easy to use. Additionally, those skilled in the art will perceive improvements, changes, and modifications from the above description of the invention. Such improvements, changes and modifications within the skill of the art are intended to be covered by the appended claims. It is important, therefore, that the claims be regarded as including such equivalent constructions insofar as they do not depart from the spirit and scope of the present invention. Though some features of the invention may be claimed in dependency, each feature has merit when used independently.

What is claimed is:

1. A lighting apparatus comprising:
a rigid housing, the housing defining a linear channel into which a plurality of light sockets may be installed in a space apart manner; and
a mounting handle coupled to the housing, the mounting handle defining an opening wherein mounting hardware may be inserted through the opening to mount the lighting apparatus.

2. The lighting apparatus of claim 1 wherein the housing includes a first side wall, a second side wall, and a top wall that define the channel, with the top wall extending beyond the side walls to form two exterior flanges.

3. The lighting apparatus of claim 2 wherein the mounting handle further includes a base section, a first mounting channel section, and a second mounting channel section that define a mounting channel, and the mounting channel is sized to fit around the top wall and two exterior flanges of the housing and thereby couple the mounting handle to the housing.

4. The lighting apparatus of claim 1 further including a plurality of light sockets installed within the channel defined by the housing.

5. The lighting apparatus of claim 2 wherein the side walls include interior flanges extending inwardly and further including a holding clip mountable to the interior flanges and sized to extend between light sockets.

6. A lighting apparatus comprising:
a rigid housing, the housing defining a linear channel into which a plurality of light sockets may be installed in a space apart manner;
a mounting handle coupled to the housing, the mounting handle defining an opening wherein mounting hardware may be inserted through the opening to mount the lighting apparatus; and
an installation handle coupled to the housing, the installation handle defining an opening wherein an installation tool may be inserted through the opening to support the lighting apparatus during installation.

7. The lighting apparatus of claim 6 wherein the housing includes a first side wall, a second side wall, and a top wall that define the channel, with the top wall extending beyond the side walls to form two exterior flanges.

8. The lighting apparatus of claim 7 wherein the installation handle further includes a first mounting channel section, and a second mounting channel section that define a mounting channel, and the mounting channel is sized to fit around the top wall and two exterior flanges of the housing and thereby couple the mounting handle to the housing.

9. The lighting apparatus of claim 6 further including a plurality of light sockets installed within the channel defined by the housing.

10. The lighting apparatus of claim 7 wherein the side walls include interior flanges extending inwardly and further including a holding clip mountable to the interior flanges and sized to extend between light sockets.

11. A lighting apparatus comprising:
a rigid housing, the housing defining a linear channel into which a plurality of light sockets may be installed in a space apart manner; and
a face plate coupled to the housing, the face plate defining a plurality of openings, the face plate extending in front of the housing.

12. The lighting apparatus of claim 11 wherein the housing includes a first side wall, a second side wall, and a top wall, and the second side wall includes a first groove section and a second groove section, and the groove sections define a groove channel.

13. The lighting apparatus of claim 12 wherein the face plate includes a main section and a tongue section extending from the main section, the tongue section sized to fit within the groove channel of the housing.

14. The lighting apparatus of claim 11 further comprising a mounting handle coupled to the housing, the mounting handle defining an opening wherein mounting hardware may be inserted through the opening to mount the lighting apparatus.

15. The lighting apparatus of claim 11 further including an installation handle coupled to the housing, the installation handle defining an opening wherein an installation tool may be inserted through the opening to support the lighting apparatus during installation.

16. The lighting apparatus of claim 11 further including a plurality of light sockets installed within the channel defined by the housing.

17. The lighting apparatus of claim 11 wherein the openings defined by the face plate are a single decorative shape.

18. The lighting apparatus of claim 17 wherein the decorative shape is a star.

19. The lighting apparatus of claim 11 wherein the openings defined by the face plate are letters.

20. The lighting apparatus of claim 19 wherein the letters for the phrase Happy Holidays.
